(19) United States
(12) Patent Application Publication
(10) Pub. No.: US 2007/0055869 A1
(43) Pub. Date: Mar. 8, 2007

(54) Record carrier, read-out device and method for reading carrier data and network data

(76) Inventors: Yang Peng, Shanghai (CN); Sheng Kim, Shanghai (CN); Baoxiong Wang, Shanghai (CN); Declan P. Kelly, Shanghai (CN); Bei Wang, Shanghai (CN); Thomas Boltze, Shanghai (CN); Wilhelmus Franciscus Johanne Fontijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/565,147

(22) PCT Filed: Jul. 12, 2004
(86) PCT No.: PCT/IB04/51190

§ 371 Date: Jan. 19, 2006

(30) Foreign Application Priority Data
Jul. 22, 2003 (EP) 03102257.7

(51) Int. Cl. G06F 21/00

(52) U.S. Cl. 713/162

(57) ABSTRACT

The present invention provides a solution to protect network data stored on a network unit within a network related to a carrier data stored on a record carrier. A copy protection system already provided for protecting a carrier data is used therefore so that in a key locker stored in a key locker area (22) of the record carrier (2) a network dat identifier (URL) identifying the network data to be used for retrieval of said network data om the network (4) and a decryption key (DK) to be used by a read-out device (1) for d cryption of encrypted network data are stored. The network data identifier (URL) is used to et access to the network data, and the decryption key (DK) is thereafter used to decrypt enc pted network data if access to the network data is permitted.

The present invention relates to a record carrier comprising a data area for storing carrier data and a key locker area for storing keys. The present invention relates further to a read-out device and a corresponding method for reading carrier data from a record carrier and network data related to said carrier data stored in the network.

A SFFO (Small Form Factor Optical) disc as a portable, high capacity and low cost storage medium is quite suitable for use in mobile hand-sets and other portable devices like PDAs and tablet-PCs. To protect content stored on such a SFFO disc copy protection systems are provided which can be incorporated by the SFFO logical format. Basically, contents (also called carrier data in the following) stored on the disc are encrypted, and the corresponding decryption key is stored as asset key or asset ID in a key locker stored in a key locker area on the disc. Only authenticated applications which authenticate with an appropriate application ED can access the required key for decryption of the corresponding file, in particular via a so-called SAC (Secure Authentication Channel).

Contents are more and more not only stored on record carriers, in particular discs or tapes, but also within networks, particularly on a server (also called network unit in the following) within a network. Often, the record carrier then comprises a user's annotation or some up-to-date disc related contents, such as new version of navigation menu, extra sound tracks/audio commentary streams on the server, for instance on a ROM disc. Also particular record carriers like a SFFO disc or a “WebDVD” are provided. During playback disc related network data, for instance web contents stored on a server within the internet, are retrieved from the network unit (e.g. a web server) and synchronized with the local content on the disc. Under many circumstances, disc related contents also need to be protected against unauthorized copying or unauthorized access, so that only when the required key, i.e. the disc itself, is present, access to the corresponding content on the network unit is permitted.

WO 01/09703 A1 discloses a system for protecting information of the internet. In order to decrypt a content information file downloaded from a web site a request is sent to a content protection system for a decryption key. The content protection system determines, based on respondent, view and survey identifiers and associated exposure limit information, whether to send a decryption key. If so, the client computer system is enabled to decrypt the encrypted content information file and to show the decrypted content information on a display.

It is an object of the present invention to provide a solution for the protection of carrier data related network data in a reliable way which does not require authentication of a read-out device (client system) with a copy protection system via the internet. In particular, a record carrier, a read-out device and a read-out method shall be provided which enable the protection of content stored on a network unit within a network.

This object is achieved according to the present invention by a record carrier as claimed in claim 1 according to which the key locker area is adapted for storing a network data identifier identifying network data related to said carrier data stored in a network to be used for retrieval of said network data from said network and for storing a decryption key to be used by a read-out device for decryption of encrypted network data.

This object is further achieved by a read-out device as claimed in claim 6 comprising:

a reading means for reading carrier data from a data area of said record carrier and for reading a network data identifier identifying said network data and a decryption key to be used for decryption of encrypted network data from a key locker area of said record carrier, and

an application unit for running an application and for retrieving said network data from said network, said application unit comprising an access means for accessing a network unit of said network to retrieve said network data, a check unit for checking if said network data identifier corresponds with said network unit and a decryption unit for decryption of retrieved encrypted network data.

An appropriate read-out method is defined in claim 10 which comprises the steps of:

reading carrier data from a data area of said record carrier,

reading a network data identifier identifying said network data and a decryption key to be used for decryption of encrypted network data from a key locker area of said record carrier, accessing a network unit of said network to retrieve said network data from said network, checking if said network data identifier corresponds with said network unit, and decrypting retrieved encrypted network data.

The present invention is based on the idea to protect network data by use of already available means of a copy protection system for protection of the carrier data stored on the record carrier, i.e. to use a key locker provided in a key locker area. It is thus proposed to store a network data identifier which will be used to identify the carrier data related network data in the network and a decryption key which is to be used to decrypt encrypted network data in said key locker. When the network data are required during playback, the network data identifier will be used to identify the network data, i.e. to find the appropriate network unit and the location where the requested network data are stored. Further, the decryption key is thereafter used to decrypt encrypted network data which can then be played back. The steps of accessing the appropriate network unit, checking if the network data identifier corresponds with the network unit and decrypting retrieved encrypted network data will be performed by an application unit running an application. No authentication of the application unit with a network unit or a copy protection system within the network is thus required.

Preferred embodiments of the invention are defined in the dependent claims. Preferably the network data identifier comprises a network address, in particular an URL (Uniform Resource Locator) or a regular address expression indicating an address a resource or a group of addresses/resources within a network, in particular the internet, at which the network data are stored. In this context a regular address expression shall mean an URL which may comprise wild cards to represent a (group of) address(es)/resource(s) within a network, such as http://www.studios.com/protected_content/*.mpg. The term network address shall thus cover URLs as well as such regular address expressions.

According to another embodiment a password or a certificate for authentication to be used by a read-out device for getting access to password-protected network data or network requiring authentication, respectively, are stored in the key locker area. Thus, an application can get transparent access to the network unit without any specific measures on the side of the network unit.

Besides keys a key locker generally also includes a rightsstring of variable length which can be used freely by application developers to insert comments or any other information, which could be used by the corresponding application. According to the present invention it is proposed to store the network data identifier and the decryption key in the rightsstring which will then be accessed and evaluated by the application unit before or during downloading of the network data. Since the rightsstring can be freely used this provides a simple and easily implementable solution.

A preferred embodiment of the read-out device comprises a synchronization unit for synchronizing the retrieved network data with the carrier data. Online content synchronized with local on-disc content is one of the key features that WebDVD (i.e. Enhanced DVD) offers. It is controlled by applications through some APIs defined for WebDVD.

In order to ensure that no unauthorized party gets access to the decryption key when being transmitted from the reading means to the application unit within the read-out device a secure authentication channel (SAC) is preferably established between the reading means and the application unit. Furthermore, a secure authentication channel is also established between the application unit and the network unit so that the requested network data can be transmitted over said channel. Appropriate channel creation means are therefore provided in the read-out device.

As already mentioned the present invention is preferably used in a small form factor optical drive used in mobile hand-sets and other portable devices. However, the invention can generally be used in all other read-out devices, preferably in PC-based devices enabling access to a network such as the internet.

The invention will now be explained in more detail with reference to the drawings in which

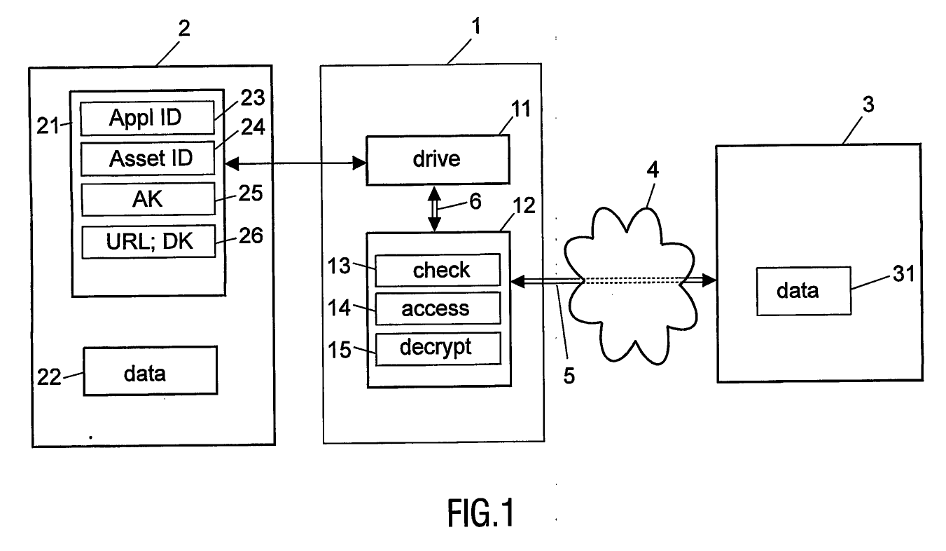

FIG. 1 illustrates the invention by use of a first embodiment of a read-out device and a record carrier,

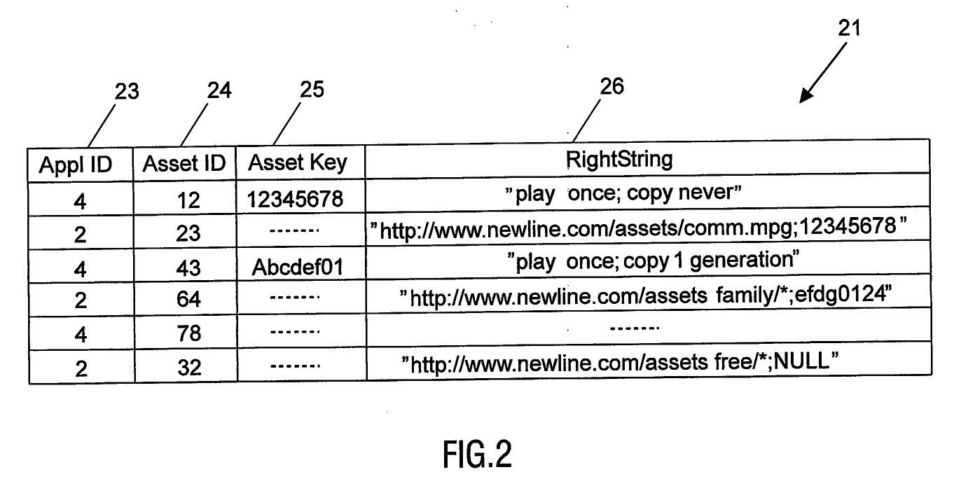

FIG. 2 shows a table illustrating the contents of a key locker,

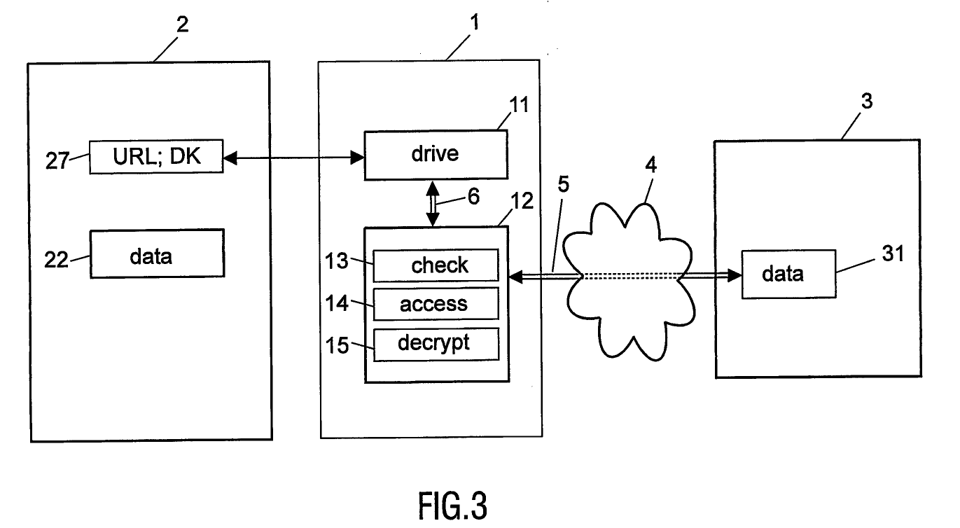

FIG. 3 shows a second embodiment of a record carrier, and

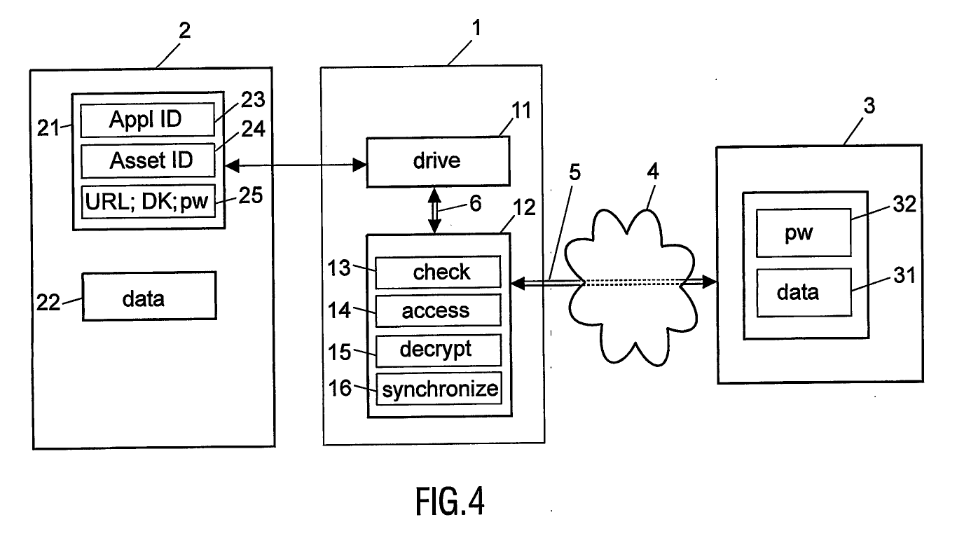

FIG. 4 shows a third embodiment of a record carrier and a second embodiment of a read-out device.

FIG. 1 schematically illustrates the use of the invention in a system comprising a read-out device 1, a record carrier 2 and a network unit 3 of a network 4. To give a particular example, the read-out device 1 is a mobile hand-set, the record carrier 2 is an optical disc like a CD, DVD or BD disc and the network unit 3 is a web server within the internet 4.

The read-out device 1 comprises a drive 11 for accessing the record carrier 2 and an application unit 12 for running an application. On the record carrier 2 a key locker area 21 for storing a key locker and a data area 22 for storing carrier data, e.g. audio, video, software data or any kind of information, are provided. The network unit 3 comprises a data area 31 for storing network data which are related to the carrier data stored in the data area 22 of the record carrier 2.

The key locker stored in the key locker area 21 is generally a table with four columns as also shown in FIG. 2. The application ID 23 is used in the authentication process of a read-out device 1 and is used to restrict the access to a subset of the key locker. The asset ID 24 is an identification of (a group of) files that are encrypted in the same key and have the same usage rights. The asset key (AK) 25 is used by the drive for decryption. It is generally kept secret by the drive 11 so that it can not be read by the application unit 12. The rightsstring 26 has an undefined format and a variable length. It can be used freely by application developers. To give an example of the usage of these IDs and keys referring to the table shown in FIG. 2, an application or a read-out device that authenticates with “application ID=4” can only access assets 12, 43 and 78. For asset 12 an asset key “12345678” is defined and the usage right is “play once; copy never”.

According to the present invention it is proposed that the rightsstring 26 is used to store a network identifier, in this particular embodiment an URL, and a decryption key DK to be used for decryption of content accessed at the address identified by said URL. For instance, with reference to FIG. 2, the asset 23 (second row) includes a reference to web-site “http://www.newline.com/assets/comm.mpg” and a decryption key “12345678”.

When web contents are required during playback, the following steps will be performed to decrypt content from the web server:

a) The trusted application running in the application unit 12 establishes a secure authentication channel 5 with the web server 3 and requests specific disc related web content on the server 3.

b) The trusted application authenticates with the drive 11 and creates a secure authentication channel 6 in between.

c) The drive 11 opens the key locker of the key locker area 21 and retrieves the rightsstring 26 of the requested asset.

d) The rightsstring 26 is sent to the application unit via the SAC 6.

e) The application then checks by use of a check unit 13 whether the URL of that specific web content matches the URL (or regular address expression if the URL comprises wild cards) stored in the rightsstring. If they don't match, the web content will be regarded as unencrypted and is retrieved directly.

f) If the URLs match the application accesses the web server by use of an access unit 14 and retrieves the network data By use of the decryption key included in the read rightsstring the retrieved (encrypted) network data are decrypted in a decryption unit 15.

g) Finally, all the obtained network data are decoded and rendered by the application unit 12.

It should be noted that the application that reads the key locker via the drive and the application that accesses the web-site need to be the same or at least both trusted with the SAC in between. A trusted application is not allowed to hand over key locker data to other (non)-trusted applications.

It should be further noted that step e) has alternatives. When accessing a web-site it can be anticipated that many small files are received most of which are just symbol page elements. It is thus not desirable to check all those. Therefore, it first can get an indication that a file is encrypted, and only then the URL is checked. Such an indication could be sent via the SAC 5, or a downloaded file could have an encryption indicator (flag) in its header.

Another embodiment of the invention is illustrated in FIG. 3. According to this embodiment the URL and the decryption key for the network data are stored on the record carrier 2 as a file 27 protected against unauthorized access by a copy protection system. This file 27 can be accessed by the trusted application running in the application unit 12 and can be used to decrypt the network data downloaded from the network unit 3. This file 27 has preferably read-only usage right and no copyrights. This embodiment fits completely within known copy protection systems and does not require any changes. Also the copy protection system can update this file so that, for example, the web server 3 or the trusted application of the application unit 12 can change the keys or the rights indicated in this file.

A still further embodiment of the invention is illustrated in FIG. 4. According to this embodiment the web-site 3 containing a network data 31 is protected by a password 32. By storing the password for this web-site 3 in the key locker, more particularly in the rightsstring 25 together with the URL and the decryption key, the application can get transparent access to the web-site 3 without any specific measures of the copy protection system at the server side. Alternatively or in addition to the password protection an authentication requirement can be foreseen meaning that access to the network data requires authentication in advance. In this case the certificate for authentication can be encrypted and stored in the key locker of the record carrier 2.

As a further addition, the application unit 12 includes a synchronization unit 16 which, after download and decryption of the network data, synchronizes the decrypted network data with the corresponding carrier 22 stored on the record carrier 2.

According to the present invention network data stored on a network unit of a network, such as the internet, which are related to carrier data stored on a record carrier can be well protected by a copy protection system already provided for protection of the carrier data.

1. Record carrier (2) comprising
a data area (22) for storing carrier data and
a key locker area (21) for storing a network data identifier (URL) identifying network data related to said carrier data stored in a network (4) to be used for retrieval of said network data from said network and for storing a decryption key (DK) to be used by a read-out device (1) for decryption of encrypted network data.

2. Record carrier as claimed in claim 1, wherein said network data identifier comprises a network address (URL) indicating an address or a group of addresses within a network (4) at which said network data are stored.

3. Record carrier as claimed in claim 1, wherein said key locker area (22) is further adapted for storing a password or a certificate for authentication to be used by a read-out device (1) for getting access to password-protected network data or network data requiring authentication, respectively.

4. Record carrier as claimed in claim 1, wherein said network data identifier (URL) and said decryption key (D)K) is stored in the rightsstring (26) of said key locker area.

5. Record carrier as claimed in claim 4, wherein said rightsstring (26) can be updated by a trusted application running on a read-out device.

6. Read-out device (1) for reading carrier data from a record carrier (2) and network data related to said carrier data stored in a network (4) comprising
a reading means (11) for reading carrier data from a data area (22) of said record carrier (2) and for reading a network data identifier (URL) identifying said network data and a decryption key (D)K) to be used for decryption of encrypted network data from a key locker area (22) of said record carrier (2), and
an application unit (12) for running an application and for retrieving said network data from said network (4), said application unit (12( comprising an access means (14) for accessing a network unit (3) of said network (4) to retrieve said network data, a check unit (13) for checking if said network data identifier (URL) corresponds with said network unit (3) and a decryption unit (15) for decryption of retrieved encrypted network data.

7. Read-out device as claimed in claim 6, further comprising a synchronisation unit (16) for synchronising said retrieved network data with said carrier data.

8. Read-out device as claimed in claim 6, further comprising channel creation means for establishing secure authentication channels (5, 6) between said application unit (12) and said reading means (11) and/or said network unit (3).

9. Read-out device as claimed in claim 6, wherein said reading means (11) is a small form factor optical drive.

10. Read-out method for reading carrier data from a record carrier and network data related to said carrier data stored in a network (4) comprising the steps of:
reading carrier data from a data area (22) of said record carrier (2),
reading a network data identifier (URL) identifying said network data and a decryption key (DK) to be used for decryption of encrypted network data from a key locker area (21) of said record carrier (2),
accessing a network unit (3) of said network (4) to retrieve said network data from said network,
checking if said network data identifier (URL) corresponds with said network unit (3), and
decrypting retrieved encrypted network data.
